(19) United States
(12) Patent Application Publication
(10) Pub. No.: US 2006/0253533 A1
(43) Pub. Date: Nov. 9, 2006

(54) Method and system for "walled garden" secure filtered web browser

(76) Inventors: Marcelo Bursztein, Ottawa (CA); Steve Mulligan, Ottawa (CA); Patrick Lajeunesse, Ottawa (CA)

Correspondence Address: PILLSBURY WINTHROP SHAW PITTMAN, LLP, P.O. BOX 10500, MCLEAN, VA, 22102, US

(21) Appl. No.: 11/402,829

(22) Filed: Apr. 13, 2006

Related U.S. Application Data
(60) Provisional application No. 60/671,344, filed on Apr. 13, 2005.

(51) Int. Cl. G06F 15/16

(52) U.S. Cl. 709/204

(57) ABSTRACT

The present invention is a method and apparatus for filtering and monitoring of data transmissions in either a school, home or work setting to permit a third party to administer and configure the system to limit and control the received information and particularly the pages to be delivered to the recipient in accordance with the administrator's determination of the level of security required for the particular recipient or group of recipients.

### REFERENCE TO RELATED APPLICATIONS

This application claims the benefit of U.S. Provisional Patent Application No. 60/671,344 filed Apr. 14, 2005, which is hereby incorporated herein by reference in its entirety.

### BACKGROUND OF THE INVENTION

Globalization has become the watchword both in commerce and education. A company that does not look beyond its own borders, be those the town in which it is located or the country in which it principally operates, is at a disadvantage. It will not be able to take advantage of opportunities that are available, may not be able to maximize its productivity and could well perform at sub-optimal levels because of inadequate information and data flow. The same is true in education. Children who do no integrate technology into their learning experience will be foreclosed from future opportunities. Unless children learn, at an early age, that there is a world with different views all of which may have validity within the context of the environment in which the views are held, they may well be unable to assimilate into the world and contribute to changing views. Life today is not a microcosm. It requires a global approach.

Although globalization is a reality, security over the global networks of today is not. Throughout the world, educators are realizing that providing security for children is of paramount importance, but the teachers, administrator and means to do that are severely limited. This need creates a children and egg scenario. How does one permit communication without knowing the content of what is being communicated and the appropriateness of the information being communicated without communicating it? There is then the question of whether the information being exchanged is appropriate. How is a teacher or parent or administrator to know whether a child at home or a student at school is receiving information on a project or an unwanted solicitation? How is a student to know if what they are sending is offensive or even profane to the recipient? These and related issues mandate that here must be a level of filtering and monitoring of the exchanges in order to maintain the integrity of the collaborative process.

In order to permit effective collaborative interaction, whether in a school environment, a home or a business context, between people, it is essential to provide a filter of some type to which can be varied depending on the recipient of the information. Indeed, in the case of small children, it is desirable to create a walled garden which will permit them to interact, but shield them from the predators outside the garden. Providing such a system will enhance reading, writing and language art skill and permit access to information that would otherwise not be readily achievable. Depending on the people communicating, there is often a need to filter the material being transmitted and monitor it for inappropriate content. It creates real audiences in real time with a level of control that make the interaction secure.

### DESCRIPTION OF THE METHOD AND SYSTEM

The browser can be integrated and made a part of a filtering and monitoring system for a school or other controlled environment. Because of the hierarchical nature of the filtering and monitoring system, an administrator can configure the browser to require that it checks all pages before they are delivered. The administrator can also configure the system so as to prevent access to any other browser, making the filtered browser the only one available to the users. Because the filtering and monitoring system has varying levels of control available at each level of the hierarchy and can be configured down to the individual user level, it permits the overall system to remain secure, while still providing appropriate browser capabilities to the users, be they students or teachers.

Browser Administration

The administration of the system is carried about remotely through the use of a client application (such as a Web browser). The administrator uses the client application to communicate with a central administrative server to read and update configuration information. When a user logs into the Browser, the configuration is pulled from the central server. This approach makes it possible for administrators to manage their configurations from any location with Internet access

Administrative Interface

Browser settings page

Browser settings can easily be applied to individuals or groups of users, or an entire school or district at once.

Define Start page URL

The administrator can enter a URL for users to visit automatically when they login to the browser.

Enter block message

The administrator can enter the message that will appear for users when they try to access a blocked resource.

Hide addressbar

The administrator can choose to not allow users to see and use the browser's addressbar. Browsing mode

The administrator can choose to allow users to surf under a “black list,” “white list,” or neither.

Add/Edit keywords interface

Allow administrators to add or exclude words on the keyword list.

Allow pop-ups

One feature that the administrator can activate prevents some sites from pushing ads.

Content filtering

This switch can turn filtering on or off for the selected user or users. For example, administrators may want to turn filtering off altogether for staff.

Allow downloads

Allows administrators to determine whether users should be able to download files with the browser.

System blocking
Allow any application to launch, but only allow the browser to have Internet access
Block everything that is not the browser, hide start menu, block ctrl-alt-del. functions from the keyboard
Or off altogether
   Allow https

Can prevent access to secure sites.

Check URL interface

Text area where uniform resource locators (URLs) can be entered.

Pages will be blocked at or below the URL entered—if the top level domain of a website is entered, all pages in that site will be blocked. The URL entered is downloaded and its content scanned. The system checks the entered URL and determines whether or not it would be blocked using the current settings for the active configuration. The administrator then has the opportunity to change the status of the entered URL (for example, to block a URL that would otherwise have been accessible).

Checking/Adding words

This interface allows the administrator to view the current filtered word lists, and add or remove words as desired. The administrator can also enter a word into a search field to see if the word would be filtered as written. If a word on the Master Flagged Word List is found, the administrator is given the option to no longer flag it in the browser. Similarly, if the word is not found, the administrator can add it to the list.

Client Application

The client application (browser) consists of two main components. The first is an HTTP client application and HTML renderer (browser). The browser accesses Web resources, filters them based on the means described herein, and, if it passes the filtering, renders them onscreen for users to view. The second is a system-blocking application (sysblock). Sysblock resides on the client machine and prevents unapproved applications from launching. This combination allows for complete control over users'desktops and browsing experiences.

Client Application Dynamic Configuration

In order to use the Client Application, the user is required to authenticate themselves (through a username and password combination). The username and password are checked against a central server for verification. If the username and password are valid, then a new configuration file is transmitted to the Client Application. The Client Application is then updated based on the configuration file. Once the Client Application is updated, the user is free to navigate within the confines of that configuration.

### PREFERRED EMBODIMENTS OF THE INVENTION

### Example 1

### Page blocking

Pages are checked against all of the below before being displayed to the user. If it is to be blocked, the user sees a dialogue explaining that the page is blocked. Text for the dialogue can be configurable on both host and the user level. Each of these can be turned on or off for an entire license, school, or any other group of or individual users.
Only Allow site list (white list) an be used to restrict access to a group of known sites.
Sites on this list will still be scanned for content unless they also appear on the Do Not Filter list.

Do Not Filter site list Content scanning will not take place on sites in this list.

Never Allow site list

Sites on this list will always be blocked - content scanning will not take place.

Content scan of the page

Page content is scanned. Pages with content that triggers filter flags will not be displayed.

Scanning form input

When users type information into a form (such as a search engine), the browser scans the input before it is submitted. This can effectively stop users from searching for sites that may contain questionable content, even before they attempt to load them.

### Example 2: Auto-Update

The browser can be required to check for updates on hosting server every time it is run (or some set interval), and automatically install updates the next time the browser is launched.

### Example 3: SchoolMail database integration

When launching the browser, the user must login using a dialog within the application. The user is logged in on the hosting server and the user's personal settings are pulled from the database. A default set of behaviors for the browser may be used in the case of users entering nothing or ‘guest’. This behavior could range from no access to access only to the hosting website, to full access with filtering. The default behaviors will be applied to the application itself, and would only change if the hosting server or the administrator pushed the update to the user.

Settings are applicable on a user basis, with administration interfaces within the monitoring and filtering system, allowing the administrators to assign settings to groups or individual users.

### Example 4: Customized look and feel

The host can design an interface which will allow customized interface elements based on user preferences.

### Example 5: Bookmarks stored on server

It is a further advantage to permit bookmarks to ‘follow’ the user, making them always accessible regardless of the computer used. In addition, the district will maintain a list of bookmarks that are always available and can be edited by administrators.

The host can also maintain its own list of bookmarks that will be pushed to every user regardless of other settings.

### Example 6: History purged after each session

In order to avoid excess storage use, the history will not stay with the user unless specified, so each user will start fresh when they login to the browser.

### Example 7: Multilingual keywords

The system will allow the browser to scan and block sites in languages other than English (including full double-byte language support).

### Example 8: Categorized keywords

The system can categorize keywords so that entire categories could be turned on or off. For example, sexual content, violence, racism, ecommerce etc.

### Example 9: Levels of filtering

The system can operate in a manner similar to categorization above to allow administrators to define levels of blocking that might be appropriate to certain groups. Teachers, high school, middle school, and elementary can have different basic levels appropriate to them. These levels would work based on the types of keywords blocked.

### Example 10: Localized interface

The system can incorporate a simultaneous translation function including an Application Program Interface to permit all interface elements translated so the browser is accessible in all languages, with the correct language being displayed based on the user.

### Example 11: Customized look and feel based on administrator and user criteria

The system will permit the customization of buttons, icons, colors, dialogues, menus etc. based on the administrator and user criteria. Elementary school children can be given access through a simple interface, while high school students can have a more complex and rich interface.

### Example 12: Usage log

The system can be adapted to log every page/site visited by each user, allowing administrators to view reports of browsing habits of their users. This will permit additional monitoring. For example, if there is substantial late night browsing of otherwise benign-looking sites, it may raise a flag as to the nature of the sites.

### Example 13: Time usage restrictions

In an effort to further limit the improper use of the system, the browser could be allowed to run only at particular times or for a certain amount of time per user.

### Example 14: Threshold filtering

The system can be instructed to check pages for how often keywords appear to better determine whether it's likely to be a safe page or not.

While this invention has been described in conjunction with a series of preferred embodiments, it is understood that it is not limited to those embodiments and encompasses variations and modifications to what is disclosed and claimed within the scope of this invention and what can be adapted by those skilled in the art.

What is claimed is:

1. A method for filtering and monitoring information transmitted to one or more individuals when they log into the Internet using a browser comprising the steps of:
a. setting a browser filter level configuration for a particular individual or group of individuals based upon criteria established for that particular individual or group of individuals;
b. storing the browser filter level at a server location;
c. receiving a plurality of information from one or more sources over the Internet through the browser;
d. calling up the browser filter configuration from the server when the individual or group of individuals logs into the browser;
e. comparing the information received to the browser filter configuration; and,
f. preventing the information that violates the criteria established for the particular individual or group of individuals from being displayed or accessed.
